(19) United States
(12) Patent Application Publication
(10) Pub. No.: US 2005/0121423 A1
(43) Pub. Date: Jun. 9, 2005

(54) Heating in a vacuum atmosphere in the presence of a plasma

(75) Inventors: Wilmert De Bosscher, Drongen (BE); Jurgen Denul, Deinze (BE); Guy Gobin, Oostende (BE); Bart Persone, Deinze (BE); Joachim Doehler, Santa Barbara, CA (US)

Correspondence Address: FOLEY AND LARDNER;SUITE 500, 3000 K STREET NW, WASHINGTON, DC, 20007, US

(73) Assignee: ENERGY CONVERSION DEVICES, INC.

(21) Appl. No.: 10/500,855

(22) PCT Filed: Jan. 29, 2003
(86) PCT No.: PCT/EP03/01516

(30) Foreign Application Priority Data
Jan. 30, 2002 (EP) 02075507.0

(51) Int. Cl. B23K 10/00

(52) U.S. Cl. 219/121.43

(57) ABSTRACT

A method of heating in a vacuum atmosphere in the presence of a plasma, comprises the following steps: a) providing infrared radiation means (16) in a vacuum chamber (10); b) providing a first electrical conductor (18) to the infrared radiation means (16); c) providing a second electrical conductor (20) from the infrared radiation means (16); d) putting an electrical voltage over said infrared radiation means (16); e) preventing the first conductor (18) and the second conductor (20) from having an electrical voltage above +55 Volt. The advantage is that arcing is avoided.

### FIELD OF THE INVENTION

The present invention relates to a method of heating in a vacuum atmosphere in the presence of a plasma. From a more general aspect the invention also relates to a method of avoiding arcing in a vacuum atmosphere in the presence of a plasma.

### BACKGROUND OF THE INVENTION

Heating in a vacuum atmosphere is often required, by way of a first example, for heating a substrate in a vacuum deposition system. Continuing this first example, the substrate is wound from an unwinding supply roll in a vacuum chamber and is guided through subsequent deposition or coating steps before being wound on a winding roll in the vacuum chamber. After being unwound but before being coated, it is often preferred to preheat the substrate in order to obtain a good coating quality. A second example is the batch heat processing of silicon discs in vacuum. In ordinary vacuum conditions conduction or convection techniques do not work efficiently. This is the reason why radiation is used. This can be done by infrared lamps. However, heating by means of infrared lamps has some severe limitations. The electrical voltage over the infrared lamps is limited to values of about 55 Volt to 65 Volt. Increasing the value of the voltage above these values, leads to formation of secondary plasmas and arcing. As a result, the heating power is limited. As a result also, the speed of the substrate to be heated is also limited. The heating power can also be increased by providing more infrared lamps. This increased number of lamps, however, requires more space and requires more feed-throughs and higher currents through the walls of the vacuum chamber. It is hereby understood that, in general, the less the number of feed-throughs through the walls of a vacuum chamber the better since this simplifies the construction and maintenance and reduces the risk for loss of vacuum.

### SUMMARY OF THE INVENTION

It is an object of the present invention to increase the heating power when heating in vacuum.

It is another object of the present invention to avoid arcing when heating in vacuum.

It is also an object of the present invention to increase the speed of a moving substrate to be heated in vacuum.

It is still an object of the present invention to limit the number of infrared lamps when heating in vacuum.

It is still another object of the invention to heat a substrate in vacuum to higher temperatures.

According to the invention there is provided a method of heating in a vacuum atmosphere in the presence of a plasma. The method comprises the following steps:
a) providing infrared radiation means in a vacuum chamber;
b) providing a first electrical conductor to the infrared radiation means;
c) providing a second electrical conductor from the infrared radiation means;
d) putting an electrical voltage over the infrared radiation means;
e) preventing said first conductor and the second conductor from having an electric voltage above +55 Volt.

Preferably, the first conductor and the second conductor are prevented from having a positive electric voltage.

Preferably, the first conductor or the second conductor, and most preferably both, are kept electrically negative.

The invention is not limited to deposition systems such as sputtering systems but can be applied to all types of vacuum atmospheres where plasmas, i.e. ionized gases, are present. For example, the invention is applicable to plasma assisted chemical vapour deposition techniques, used e.g. for deposition of amorphous silicon.

Within the context of the present invention, the term “vacuum” refers to a pressure lower than 100 Pa (=100 mbar), e.g. lower than 10 Pa, e.g. lower than 1 Pa, e.g. 0.005 Pa. . . . .

The advantageous mechanism of the invention can be explained as follows. By keeping the first conductor and the second conductor electrically negative, it is avoided that the electrons, which are present in the plasma, are attracted to these conductors. As a consequence, electron clouds or secondary plasmas can no longer be built up around the conductors and arcing is avoided. Accordingly, the voltage put over the radiation means may be increased without substantially increasing the risk for arcing.

In a preferable embodiment of the present invention, a first feed-through is provided through which the first conductor enters the vacuum chamber. The second conductor is electrically grounded together with the walls of the vacuum chamber. This grounding avoids the need for another feed-through for the second conductor.

In another preferable embodiment of the present invention, the first conductor and the second conductor are double isolated. In addition thereto, a metal shield is wrapped around the first conductor and the second conductor. This shield is connected to earth. This avoids a charge build up from the plasma on the first and second electrical conductor.

According to a general and broader aspect of the invention, there is provided a method of avoiding arcing in a vacuum atmosphere in the presence of a plasma. The method comprises the following steps:
a) providing a vacuum chamber;
b) providing a plasma;
c) providing an electrial power to or from a device in a vacuum chamber;
d) providing a first electrical conductor to said device;
e) providing a second electrical conductor from said device;
f) preventing said first and second electrical conductor from being loaded above +55 Volt so that electrons are not attracted in mass.

### BRIEF DESCRIPTION OF THE DRAWINGS

The invention will now be described into more detail with reference to the accompanying drawings wherein

FIG. 1 shows an electrical circuit of a first embodiment of the invention;

FIG. 2 shows an electrical circuit of a second embodiment of the invention;

FIG. 3 shows an electrical circuit of a third embodiment of the invention;

FIG. 4 and FIG. 5 show the wave form of the electrical voltage at various spots in the electrical circuit of FIG. 3.

FIG. 6, FIG. 7 and FIG. 8 all show electrical circuits of preferable embodiments of the invention;

FIG. 9 shows an embodiment of an electrical circuit which is an alternative to the second embodiment of FIG. 2;

FIG. 10 shows an embodiment of an electrical circuit where a diode bridge is integrated with a power controller;

FIG. 11 shows an electrical circuit of an experimental set-up.

### DESCRIPTION OF THE PREFERRED EMBODIMENTS OF THE INVENTION

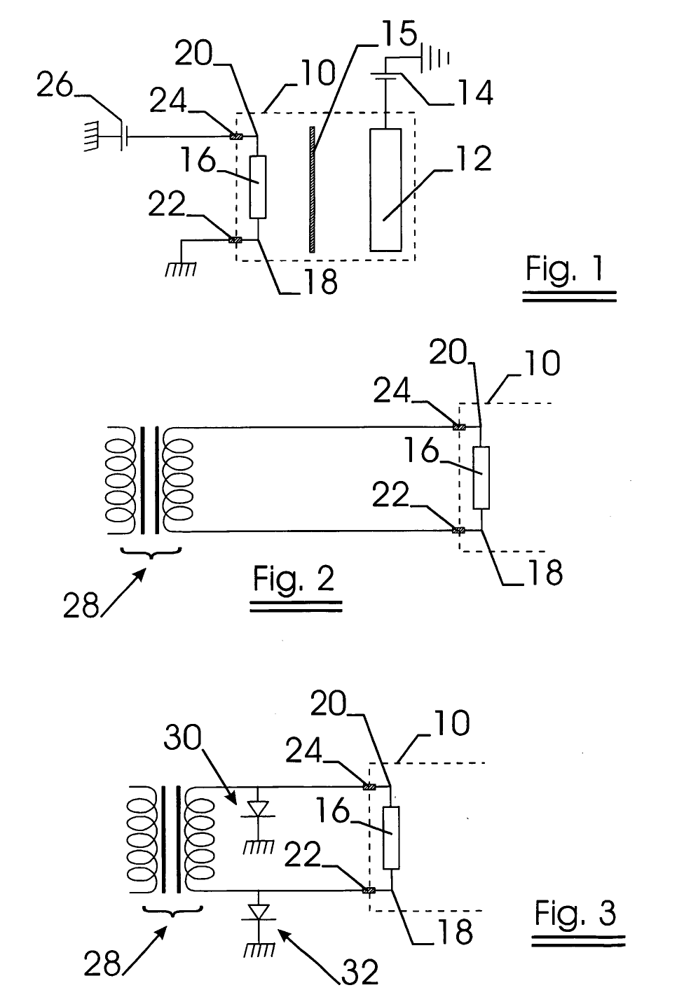

FIG. 1 shows an electrical circuit of a first embodiment of the invention. In a vacuum chamber 10 a sputter target 12 is installed. The sputter target functions as a cathode and is negatively biased through an electrical source 14. Substrate 15 is to be coated with the material of the target 12. Before or during the coating step, substrate 15 is heated by means of an infrared lamp 16. A first conductor 18 and a second conductor 20 supply electrical energy to the infrared lamp 16. Both the first conductor 18 and the second conductor 20 are electrically double isolated. In addition hereto, a metal shield is wrapped around the double isolated conductors 18, 20 and this metal shield is connected to earth (not shown). First electrical conductor 18 enters the vacuum chamber 10 through an isolated feed-through 22 and second electrical conductor 20 enters the vacuum chamber through another isolated feed-through 24. A DC power source 26 supplies electrical energy to the infrared lamp 16 and puts the infrared lamp under an electrically negative voltage. Electric conductors 18 and 20 are negative so that no electrons are attracted.

FIG. 2 shows an electrical scheme of a second embodiment of the invention. The difference with FIG. 1 is that in FIG. 2 an AC voltage source is used. The AC voltage is applied to the vacuum system via a transformer 28. The feed-throughs 22 and 24 and electric conductors 22 and 24 are not grounded. As a result the AC voltage over the infrared lamp 16 is floating. Suppose that the AC voltage is 100 V. This means that there is a maximum voltage of 141 V over the infrared lamp 16, i.e. between the electical conductors 18 and 20. The absolute voltage on the conductors is not determined, having regard to the floating nature. This can be 0 V and +141 V, or −141 V and 0 V, or −70.5 V and +70.5 V. Despite such a relatively high level of positive voltage, no arcing problems occur. This can be explained as follows. If one of the conductors becomes electrically positive, it will attract electrons.

These electrons cannot flow away, since there is no grounding. The whole secondary circuit becomes negative and prevents other electrons from being attracted. So this negative loading by the electrons prevents the conductors from having a high positive voltage. And this absence of a high positive voltage prevents a concentrated stream of electrons and thus prevents arcing. This has been confirmed in experiments, the results of which are summarized in Table 1 below.

FIG. 3 shows another electrical scheme for implementing a third embodiment of the invention. The difference with FIG. 2 is that diodes 30 and 32 filter now away the positive peaks.

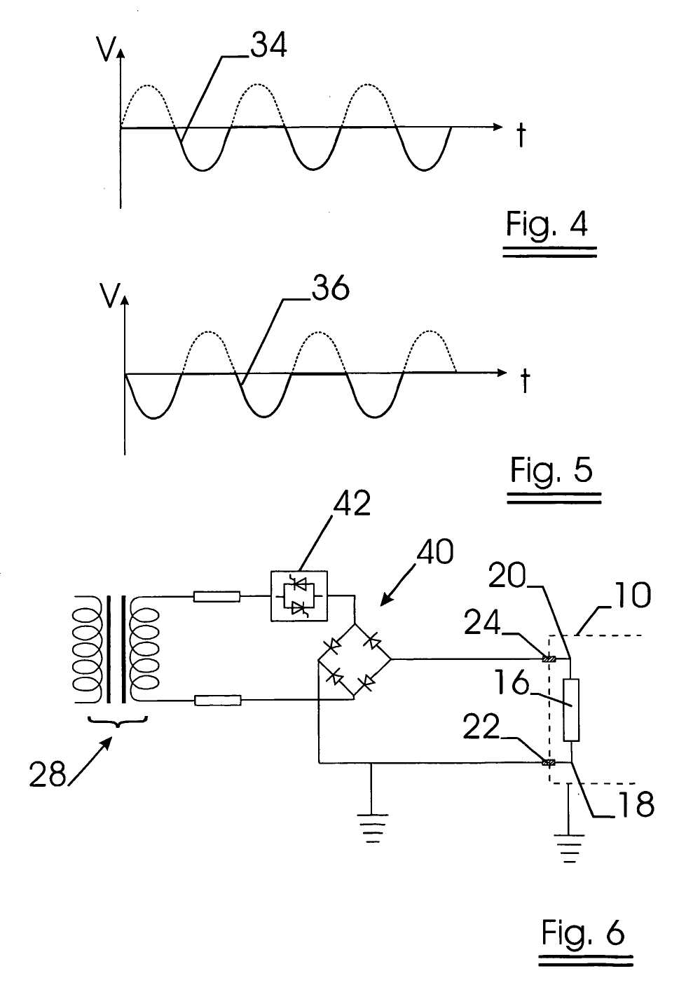

The bold line curve 34 in FIG. 4 gives the voltage at the second conductor 20. The bold line curve 36 in FIG. 5 gives the voltage at the first conductor 18. Curve 36 has a 180° phase shift with respect to curve 34.

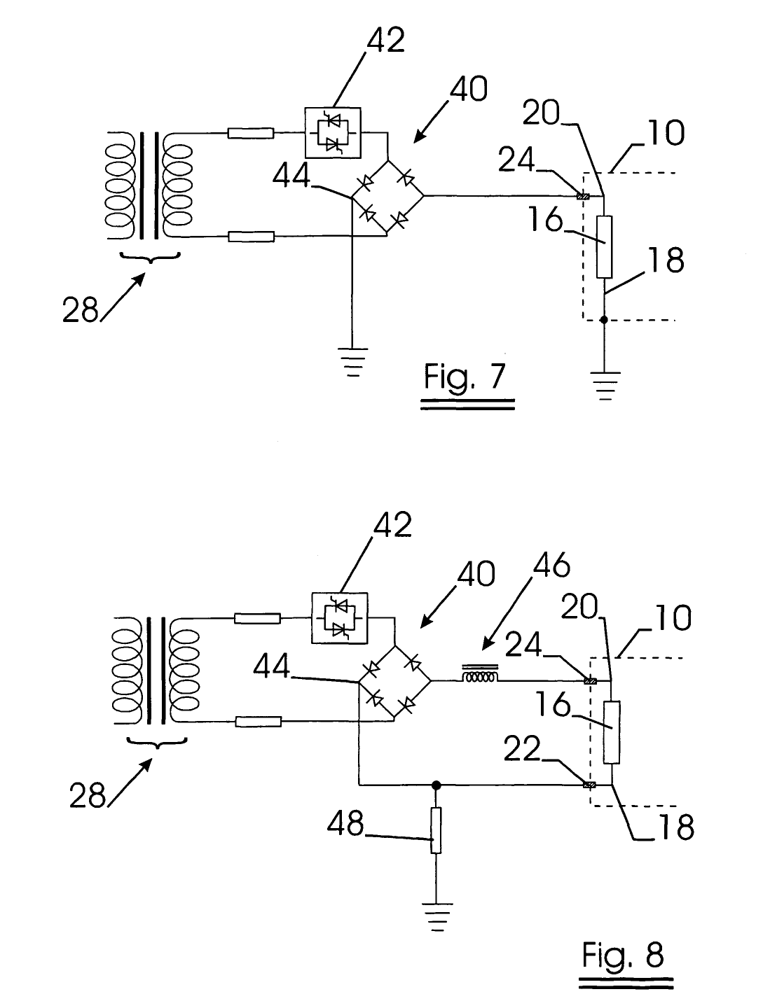

FIG. 6, FIG. 7 and FIG. 8 all illustrate embodiments where a diode bridge 40 and a thyristor controller 42 are used. The thyristor controller 42 regulates the power of the heating element.

In the embodiment of FIG. 6 two feed-throughs 22, 24 are still used.

In the embodiment of FIG. 7 the positive pole 44 is connected to earth as well as is the first electrical conductor 18. This embodiment has the advantage that only one feed-through 24 is required.

In the embodiment of FIG. 8 an extra coil 46 is provided for securing semi-conductor parts from an arc between the two electrodes. The positive pole 44 is connected to earth by way of a resistor 48.

FIG. 9 illustrates an electrical circuit which is a preferable alternative to the circuit of FIG. 2. The secondary winding of transformer 28 has three parts. A main part 59 which gives the voltage over infrared lamp 16, and two auxiliary windings. A first auxiliary winding 60 is via a diode 62 over an impedance 64 connected to the ground. A second auxiliary winding 66 is via another diode 68 and over the same impedance 64 connected to the ground. The result is that a sinusoidal voltage is across the infrared lamp 16, however, with both maximum and minimum values negative.

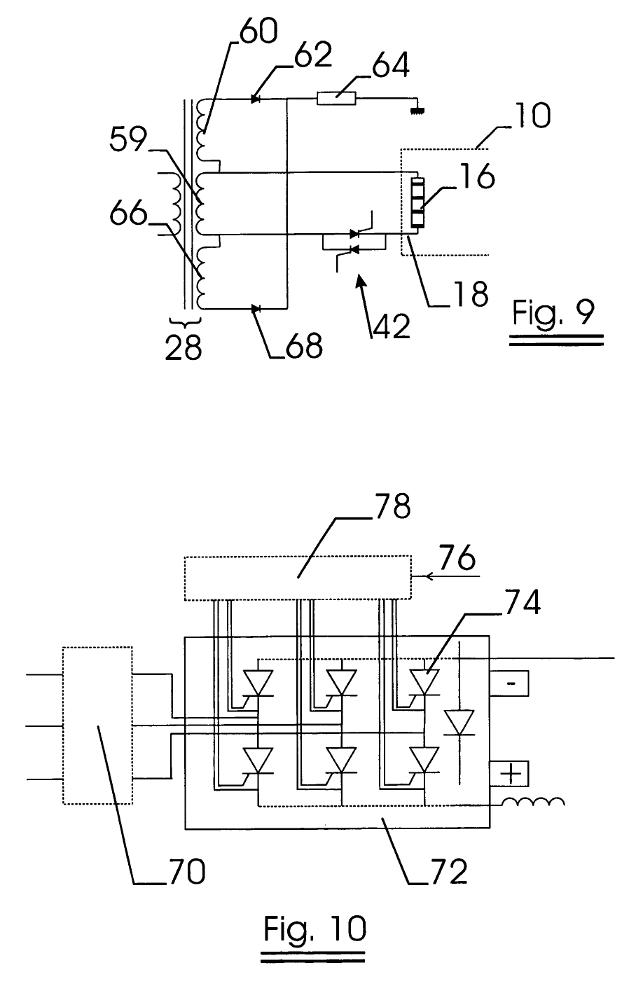

FIG. 10 shows an embodiment of an electrical circuit where a diode bridge is integrated with a power controller. 70 is a three-phase transformer. Thyristor bridge 72 is an integration of the diode bridge 40 of FIGS. 6 to 8 with thyristor controller 42 of FIGS. 6 to 8. Thyristor bridge 72 comprises six thyristors 74 and transforms the three-phase AC input signal into a single phase output signal for the infrared heater. The temperature is measured continuously and a related signal 76 is fed back to a control circuit 78 which steers the thyristors 74.

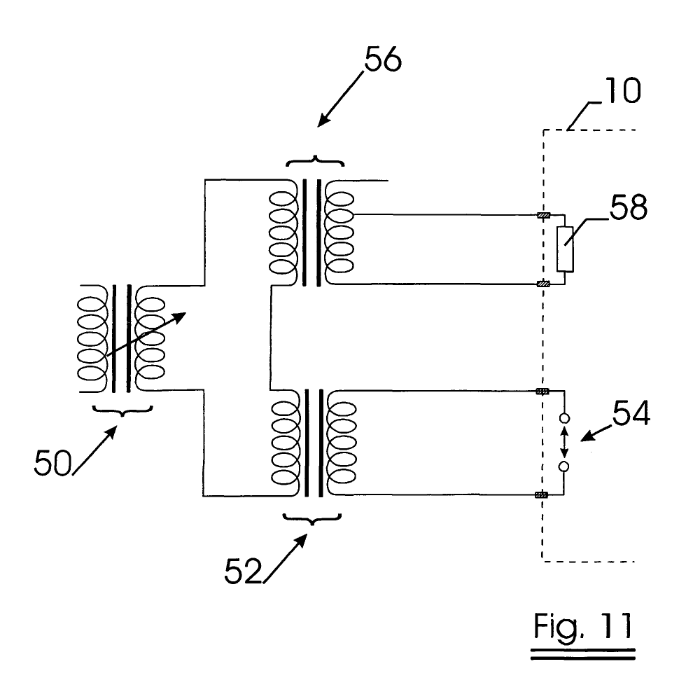

FIG. 11 illustrates an electrical circuit which was used for setting up some arcing experiments. A Variac 50 supplies variable voltages to the system. Part of the voltage goes over a transformer 52 and is put over a variable gap 54. Another part of the voltage goes over another transformer 56 and is put over a 10-Ohm resistor 58. Once an arc develops in the vacuum chamber 10, it is safely dissipated in resistor 58. An oscilloscope is connected to various points in the circuit for monitoring.

The experiments carried out consisted of adjusting the gap, pumping out the vacuum chamber, starting an Argon flow to achieve an Argon partial pressure of about 1 mTorr, starting the sputtering cathode, and subsequently increasing the Variac 50 until arcs became apparent.

Table 1 summarizes the results of the obtained data:

TABLE 1

| Exp | Gap | | | AC/ | | Arcing | |
|---|---|---|---|---|---|---|---|
| No. | (cm) | Plasma | Voltage | DC | Grounded | (No or V) | Notes |
| 1 | 1.20 | ON | 85 | AC | Y | 85 | |
| 2 | 1.20 | OFF | 85 | AC | Y | N | |
| 3 | 1.20 | ON | 85 | AC | N | N | |
| 4 | 1.20 | ON | 300 | AC | N | N | |
| 5 | 2.50 | ON | 300 | AC | N | N | |
| 6 | 2.50 | ON | 62 | AC | Y | 62 | |
| 7 | 6.98 | ON | Any | AC | N | N | |
| 8 | 9.52 | ON | 65-70 | AC | Y | 65 | |
| 9 | 8.89 | ON | Any | AC | N | N | |
| 10 | 8.89 | ON | 62 | AC | Y | 62 | |
| 11 | 12.70 | ON | Any | AC | N | N | |
| 12 | 12.70 | ON | 65 | AC | Y | 65 | |
| 13 | 19.05 | ON | 275 | AC | N | 275 | |
| 14 | 19.05 | ON | 76 | AC | Y | 65 | |
| 15 | 27.94 | ON | 82 | AC | Y | 82 | |
| 16 | 27.94 | ON | Any | AC | N | N | |
| 17 | 19.05 | ON | 65 | AC | Y | 65 | |
| 18 | 19.05 | ON | 330 | AC | N | 330 | |
| 19 | 25.40 | ON | 260 | AC | N | 260 | |
| 20 | 30.48 | ON | 275 | AC | N | 275 | |
| 21 | 30.48 | ON | 72 | AC | Y | 72 | |
| 22 | 38.10 | ON | 240 | AC | N | 240 | |
| 23 | 38.10 | ON | 60 | DC | Y− | 60 | |
| 24 | 38.10 | ON | Any | DC | Y+ | N | (*) |
| 25 | 64.77 | ON | 220 | AC | N | 220 | |
| 26 | 64.77 | ON | 221 | DC | Y+ | N | (*) |

(*) no arc at maximum voltage of 430 V

Not shown in the above Table 1 is that arcing occurs only when the ungrounded electrode is driven positive.

As may be derived from Table 1, in the absence of grounding (Grounded=N), the voltage where arcing occurs is much higher than in similar cases with grounding. For example, comparing experiment No. 5 with No. 6, there is no arcing at 300 V in the non grounded embodiment while there is already arcing at 62 V in the grounded embodiment.

1. A method of heating in a vacuum atmosphere in the presence of a plasma, said method comprising the following steps:
a) providing infrared radiation means in a vacuum chamber;
b) providing a first electrical conductor to said infrared radiation means;
c) providing a second electrical conductor from said infrared radiation means;
d) putting an electrical voltage over said infrared radiation means;
e) preventing said first conductor and said second conductor from having an electrical voltage above +55 Volt.

2. A method according to claim 1,
wherein said first conductor and said second conductor are prevented from having a positive electrical voltage.

3. A method according to claim 1,
wherein said first conductor or said second conductor are kept electrically negative.

4. A method according to claim 1,
wherein said first conductor and said second conductor are kept electrically negative.

5. A method according to claim 1
wherein said method further comprises the step of providing a first feed-through through which said first conductor enters said vacuum chamber.

6. A method according to claim 1
wherein said method further comprises the step of providing a second feed-through through which said second conductor enters said vacuum chamber.

7. A method according to claim 1
wherein said vacuum chamber has walls, said method further comprising the step of electrically grounding said walls and said second conductor.

8. A method according to claim 1
wherein said method further comprising the step of electrically isolating said first and second conductors.

9. A method according to claim 8
wherein said method further comprising the step of electrically double isolating said first and second conductors.

10. A method according to claim 9
wherein said method further comprises the step of wrapping a metal shield said first conductor and said second conductor and connecting said shield to earth.

11. A method according to claim 1
wherein said electrical voltage is greater than 65 Volt.

12. A method of avoiding arcing in a vacuum atmosphere in the presence of a plasma, said method comprising the following steps:
a) providing a vacuum chamber;
b) providing a plasma;
c) providing an electrial power to or from a device in a vacuum chamber;
d) providing a first electrical conductor to said device;
e) providing a second electrical conductor from said device;
f) preventing said first and second electrical conductor from being loaded above +55 Volt so that electrons are not attracted in mass.

13. A method of increasing heating power when heating in a vacuum atmosphere in the presence of a plasma, said method comprising the following steps:
a) providing infrared radiation means in a vacuum chamber;
b) providing a first electrical conductor to said infrared radiation means;
c) providing a second electrical conductor from said infrared radiation means;
d) putting an electrical voltage over said infrared radiation means;
e) keeping said conductors negatively loaded;
f) increasing the electrical voltage above 65 Volt.
